(19) United States
(12) Patent Application Publication
(10) Pub. No.: US 2007/0127228 A1
(43) Pub. Date: Jun. 7, 2007

(54) Dashboard illumination assembly

(75) Inventor: Roberto Zafferri, Kowloon (CN)

Correspondence Address: CHARLES E. BAXLEY, ESQ., 90 JOHN STREET, THIRD FLOOR, NEW YORK, NY, 10038, US

(73) Assignee: Wellgain Optical Communication Ltd.

(21) Appl. No.: 11/293,326

(22) Filed: Dec. 2, 2005

(51) Int. Cl. B60Q 3/04

(52) U.S. Cl. 362/30; 362/489

(57) ABSTRACT

The present invention relates to a dashboard illumination assembly for an automotive vehicle, comprising a housing and a dashboard pointer connected to the top of the housing, wherein a light source is installed inside the housing, the light emitted from the light source illuminates the dashboard pointer by passing through a light receiving surface and being reflected by a reflecting surface in the housing; and wherein a convex lensing member for converging the light is located in a light path from the light source to the light receiving surface of the pointer. The present invention has a simple structure, high illumination efficiency, low cost and high technical feasibility.

### TECHNICAL FIELD

The present invention relates to vehicle instrumentation, and more particularly, to vehicle dashboard illumination assembly.

### BACKGROUND OF THE INVENTION

Generally, a dashboard illumination assembly with an in-built light source is adopted in a dashboard of an automotive vehicle, so as to provide better safety and clearness for driving in the night. A prior art dashboard illumination assembly is shown as FIG. 1, including a housing 1, a dashboard pointer 2 connected to the top of the housing 1, wherein a light source 11 is installed inside the housing 1. The light emitted from the light source 11 is directed to the dashboard pointer 2 by passing through a light receiving surface 13 and then being reflected by a reflecting surface 12 inside the housing 1. Typically, two red or white SMD LEDs serve as the light source 11, which are integrated on a dashboard PCB 15. The light emitted from the LEDs acts as an illumination source after the light passes through the light receiving surface 13 and then is reflected by the reflecting surface 12 of the pointer. This kind of design has disadvantages as follows:
1) As shown in FIG. 1, since the light emitted from the LEDs forms a divergence angle β, which is usually 120°, most of the light does not go through the above mentioned light path from the light source 11 to the light receiving surface 13 of the pointer, but is absorbed or reflected by a cone 14 inside the housing 1, and therefore fails to effectively illuminate the dashboard pointer 2.
2) Since the light emitted from the LEDs forms a divergence angle β, the light received by the light receiving surface 13 is non-uniform. And since the LEDs are fixed on the dashboard PCB 15, the light intensity is different for different light angles when the dashboard pointer rotates at different locations. Therefore, the light intensity of the whole panel and the dashboard pointer 2 changes with the time and the location, that is, the brightness is uncertain or non-uniform, which is not good on the whole visual effect and not good for practical use.

Alternatively, there are also other designs wherein the LEDs are directly integrated on the dashboard pointer 2. However, since there are a large variety of dashboard pointers 2, such kinds of designs make the dashboard pointers complex and costly in development and manufacture.

### SUMMARY OF THE INVENTION

The object of the present invention is to provide a dashboard illumination assembly, so as to solve the problems of low efficiency and high cost in the prior art. A dashboard illumination assembly according to the present invention comprises a housing and a dashboard pointer connected to the top of the housing, wherein a light source is installed inside the housing, the light emitted from the light source illuminates the dashboard pointer by passing through a light receiving surface and being reflected by a reflecting surface in the housing; and wherein a convex lensing member for converging the light is located in a light path from the light source to the light receiving surface of the pointer.

Wherein at least one LED is used as said light source, a convex lens located in front of each of said at least one LED for converging the light is used as said convex lensing member; Said at least one LED is mounted on a base, electrodes of said at least one LED are drawn out from the bottom of the base;

Said electrodes have L-shaped legs at their outer edges;

The distance between the light source and the convex lensing member is adjustable;

Said convex lensing member may be composed of at least two lenses.

The present invention has following advantages:

The convex lensing member for converging light is located in the light path from the light source to the light receiving surface of the pointer, so that light scattering of the light source can be reduced by the convex lensing member and more of the light emitted from the light source can reach the light receiving surface of the pointer, accordingly the illumination efficiency can be improved. Moreover, the present invention has simple structure and low cost, which can be realized with less modifications on the existing structure, even more, it is possible to directly rebuild the prior structure mounted on the automotive vehicle. Since the LEDs are amounted on the base, electrodes of which are drawn out from the bottom of the base, and the electrodes have L-shaped legs at their outer edges, it is easy to fit and fix the light source, and it is convenient to weld the L-shaped legs onto the dashboard PCB, which further improves the utility of the present invention. Since the distance between the light source and the convex lensing member is adjustable, and the convex lensing member may be composed of at least two convex lenses, the converging degree of the convex lensing member for the light emitted from the light source can be adjusted by changing the relative spacing of the lenses, so that the present invention can work in an optimal status.

### BRIEF DESCRIPTION OF THE DRAWINGS

FIG. 1 is a schematic view of a prior art dashboard illumination assembly;

FIG. 2 is a schematic view of the dashboard illumination assembly according to embodiment 1 of the present invention;

FIG. 3 is an enlarged partial schematic view of the light source and the convex lensing member of the dashboard illumination assembly shown in FIG. 2;

FIG. 4 is a schematic view of the dashboard illumination assembly according to embodiment 2 of the present invention.

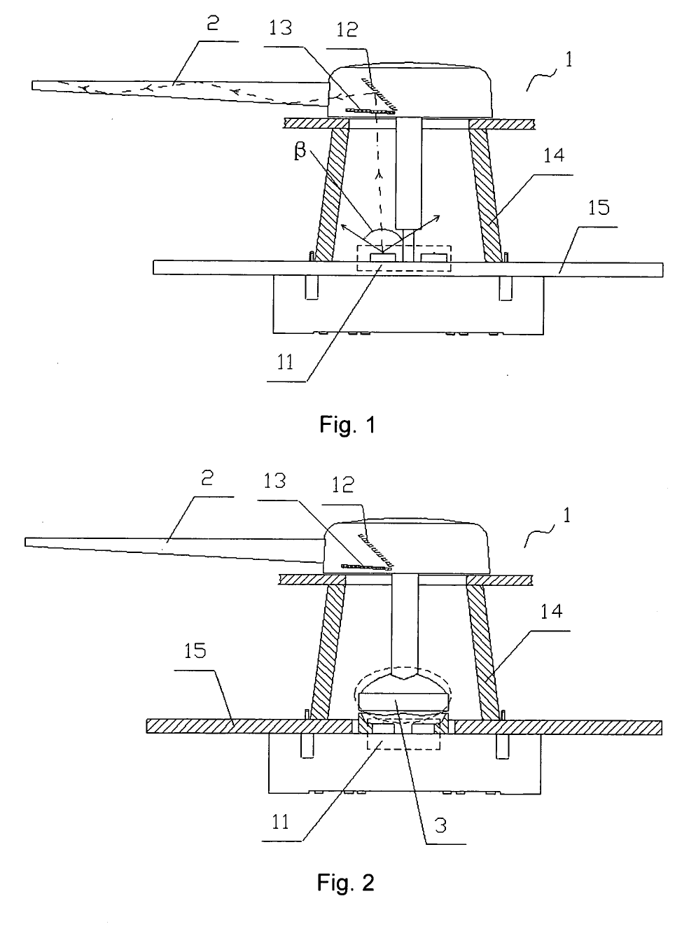

### DETAILED DESCRIPTION OF THE PREFERRED EMBODIMENTS

The present invention will be described in details with reference to the accompanying drawings and embodiments as follows:

### Embodiment 1

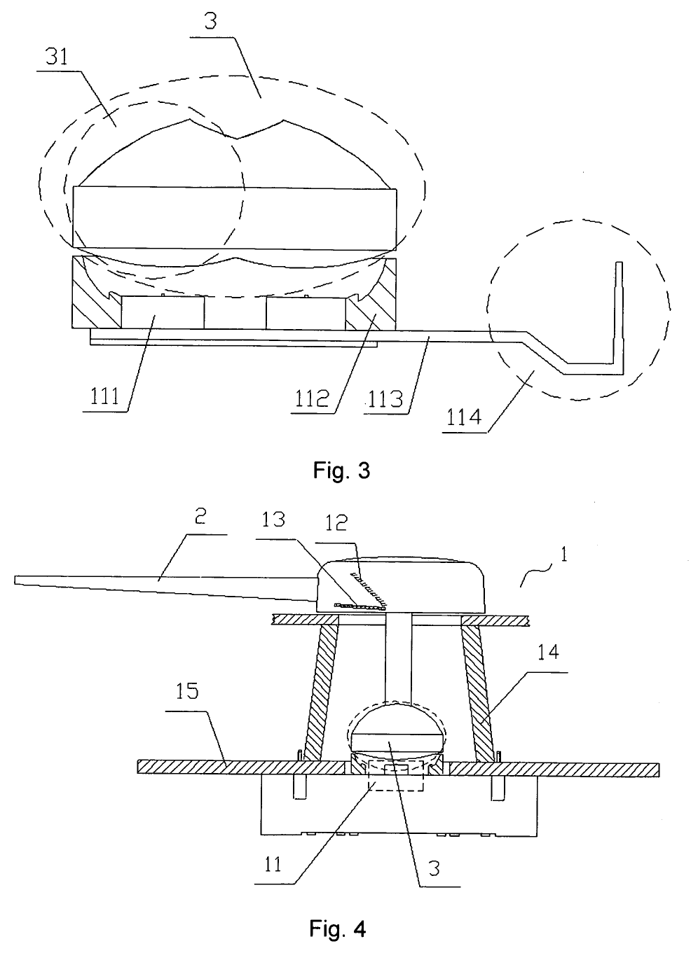

As shown in FIG. 2 and FIG. 3, the dashboard illumination assembly according to the present invention includes a housing 1 and a dashboard pointer 2 connected to the top of the housing 1, wherein a light source 11 is installed inside the housing 1, a convex lensing member 3 is located in front of the light source 11, the light emitted from the light source 11 is directed to the dashboard pointer 2 by passing through the light receiving surface 13 and being reflected by the reflecting surface 12 of the pointer 2 after being converged by the convex lensing member 3. The light source 11 contains two LEDs 111, a convex lens 31 for converging light is located in front of each of the LEDs 111, and these two convex lenses 31 constitute the convex lensing member 3 for converging light, such that the shape of the convex lensing member 3 looks like a camel's hump. The light passing the convex lens 31 becomes parallel if the LED 111 is located in the focusing plane of the corresponding convex lens 31.

As shown in FIG. 3, on a base 112 are mounted the LEDs 111, whose electrodes 113 with L-shaped legs 114 are drawn out from the bottom of the base 112.

For assembling of the present invention, and as shown in FIG. 2, the LEDs 111 are mounted on the base 112 and then the convex lensing member 3 is in place. Finally, the electrodes 113 with L-shaped legs 114 are soldered on the dashboard PCB 15 by connecting the base 112 to the dashboard PCB 15 or to the shell of the motor under the PCB 15.

In this way, in the present invention, the convex lensing member 3 for converging light is located in the light path from the light source 11 to the light receiving surface 13 of the pointer, so that the illumination efficiency can be improved. Moreover, the present invention has a simple structure and low cost.

In the present invention, the distance between the light source 11 and the convex lensing member 3 is adjustable, so as to adjust the converging degree of the convex lensing member 3 for the light emitted from the light source 11. Furthermore, the convex lensing member 3 may be composed of two or more lenses, so that, the focus of the convex lens 31 in the convex lensing member 3 can be adjusted by changing the spacing between the lenses, also the converging degree of the convex lensing member 3 for the light emitted from the light source 11 can be adjusted. By adjusting the converging degree of the convex lensing member, the present invention can work in an optimal status.

Although in this embodiment, two LEDs 111 serve as the light source 11, while more than two LEDs 111 can be adopted. In this case, a same quantity of convex lenses 31 are configured in the convex lensing member 3. As the structure of other parts, the working principle and operation method are the same as or similar to this embodiment, unnecessary details will not be given here.

### Embodiment 2

As shown in FIG. 4, and with reference to FIG. 2 and FIG. 3, the difference between this embodiment and embodiment one is that, only one LED 111 serves as the light source 11, the convex lensing member 3 is composed of only one lens 31. As the structure of other parts, working principle and operation method are the same as or similar to those of embodiment one, unnecessary details will not be given here.

What is claimed is:

1. A dashboard illumination assembly, comprising a housing 1 and a dashboard pointer 2 connected to the top of the housing 1, wherein a light source 11 is installed inside the housing 1, the light emitted from the light source 11 illuminates the dashboard pointer 2 by passing through a light receiving surface 13 and being reflected by a reflecting surface 12 in the housing 1; and wherein a convex lensing member 3 for converging the light is located in a light path from the light source 11 to the light receiving surface 13 of the pointer.

2. The dashboard illumination assembly as claimed in claim 1, wherein, at least one LED 111 is used as said light source, a convex lens 31 located in front of each of said at least one LED 111 for converging the light is used as said convex lensing member 3.

3. The dashboard illumination assembly as claimed in claim 2, wherein, said at least one LED 111 is mounted on a base 112, electrodes 113 of said at least one LED 111 are drawn out from the bottom of the base 112.

4. The dashboard illumination assembly as claimed in claim 3, wherein, said electrodes 113 have L-shaped legs 114 at their outer edges.

5. The dashboard illumination assembly as claimed in claim 1, wherein, the distance between the light source 11 and the convex lensing member 3 is adjustable.

6. The dashboard illumination assembly as claimed in claim 2, wherein, the distance between the light source 11 and the convex lensing member 3 is adjustable.

7. The dashboard illumination assembly as claimed in claim 3, wherein, the distance between the light source 11 and the convex lensing member 3 is adjustable.

8. The dashboard illumination assembly as claimed in claim 4, wherein, the distance between the light source 11 and the convex lensing member 3 is adjustable.

9. The dashboard illumination assembly as claimed in claim 1, wherein, said convex lensing member 3 is composed of at least two lenses.

10. The dashboard illumination assembly as claimed in claim 2, wherein, said convex lensing member 3 is composed of at least two lenses.

11. The dashboard illumination assembly as claimed in claim 3, wherein, said convex lensing member 3 is composed of at least two lenses.

12. The dashboard illumination assembly as claimed in claim 4, wherein, said convex lensing member 3 is composed of at least two lenses.
